(19) United States
(12) Patent Application Publication
(10) Pub. No.: US 2007/0174683 A1
(43) Pub. Date: Jul. 26, 2007

(54) Method for operating software modules

(75) Inventors: Ottmar Gehring, Kernen (DE); Harro Heilmann, Ostfildern (DE); Ansgar Maisch, Ettlingen (DE); Andreas Schwarzhaupt, Landau (DE); Gernot Spiegelberg, Heimsheim (DE); Armin Sulzmann, Oftersheim (DE)

Correspondence Address: CROWELL & MORING LLP;INTELLECTUAL PROPERTY GROUP, P.O. BOX 14300, WASHINGTON, DC, 20044-4300, US

(73) Assignee: DaimlerChrysler AG, Stuttgart (DE)

(21) Appl. No.: 10/581,862

(22) PCT Filed: Nov. 10, 2004
(86) PCT No.: PCT/EP04/12687

§ 371 Date: Jan. 25, 2007

(30) Foreign Application Priority Data
Dec. 6, 2003 (DE) 103 57 118.3

(51) Int. Cl. G06F 11/00

(52) U.S. Cl. 714/12

(57) ABSTRACT

A method for operating a software module on a processor unit in a vehicle optimizes the processor utilization level in networked controllers. The controller on which the software module is operated is selected based on the available computation capacity of the controllers which are currently in operation.

### BACKGROUND AND SUMMARY OF THE INVENTION

This application is a National Phase of PCT/EP2004/012687, filed Nov. 10, 2004, and claims the priority of German patent document DE 103 57 118.3, filed Dec. 6, 2003, the disclosure of which is expressly incorporated by reference herein.

The invention relates to a method for operating a software module on a processor unit in a controller in a vehicle, where the software module is executable in a plurality of controllers and the controllers that interchange data via a data bus.

German patent document DE 196 31 309 A1 discloses a microprocessor arrangement for a vehicle control system having a plurality of microprocessor systems which are connected to one another by bus systems.

U.S. Pat. No. 5,544,054 and 5,155,851 each disclose a method for loading software modules into a processor unit in a controller. The selection regarding the controller on which the software module is loaded is made based on the computation capacity of the controllers which are currently in operation.

European patent document EP 240 145 A2 discloses a system for selecting processors for handling tasks defined by software in a multiprocessor computer system. This method, however, cannot readily be transferred to a vehicle, due to real-time requirements and computation-time limitations. The article “fine grained mobility in the emerald system, ACM transactions on computer systems”, association for computing machinery, New York, U.S., 1988-02-00 discloses the forwarding of identifier information, such as the state of the host, in a computer system.

One object of the present invention is to optimize the processor utilization level in controllers which are networked to one another.

This and other objects and advantages achieved by the method according to the invention, in which the selection of the controller on which the software module is operated is made based on the computation capacity of the controllers which are currently in operation. This selection method ensures that the software module currently has sufficient computation capacity available on the loaded controller for executing its processes, and is not started on a controller on which there is currently insufficient computation capacity. The selection method allows targeted utilization of free computation capacities in a complex of controllers which can communicate with one another.

Preferably, the computation capacity of the controllers is ascertained in rotation or upon request. This has the advantage that it is known which controller currently has how much free computation capacity. This information can accordingly be used to control the loading of the software module onto a particular controller. The free computation capacity of a controller is dependent on the tasks which are currently to be handled by this controller, and is therefore subject to fluctuations. Thus, it needs to be communicated to the other controllers.

Advantageously, the computation capacity of a controller is ascertained from the processor utilization level and the processor type, so that, even with different processor types the free computation capacity is determined correctly; in particular, not only the processor utilization level is used.

Preferably, the software module is started on the controller with the maximum free computation capacity, so that controllers with little computation capacity are not burdened with executing the software module.

Preferably, the controller on which the software module is running compares its computation capacity with the computation capacity of the other controllers. Based on the comparison, the software module is terminated or continued by the controller. This technique has the advantage that the software module can be turned off in the event of processor utilization level alterations on the controller.

Advantageously, termination of the software module prompts ascertainment of which of the other controllers provides the maximum free computation capacity, and the software module is started on the latter controller.

It is apparent that the software module should be executable on each of the controllers, because otherwise it cannot be loaded by the controllers. Moreover, because the controllers are in ongoing operation, the software module is loaded at the runtime of at least the operating system and possibly of further software modules which have been loaded on the controller in question.

Preferably, the software module sends an identifier regarding its operating state and its operating controller (that is, an identifier for the controller on which the software module is running) to the data bus in rotation or upon request. This ensures that the correct operation can be checked and the software module can be influenced directly.

Other objects, advantages and novel features of the present invention will become apparent from the following detailed description of the invention when considered in conjunction with the accompanying drawings.

### BRIEF DESCRIPTION OF THE DRAWINGS

FIG. 1 is a schematic illustration of apparatus for carrying out the inventive method; and

FIG. 2 is a flow diagram that illustrates method sequence for carrying out the invention.

### DETAILED DESCRIPTION OF THE DRAWINGS

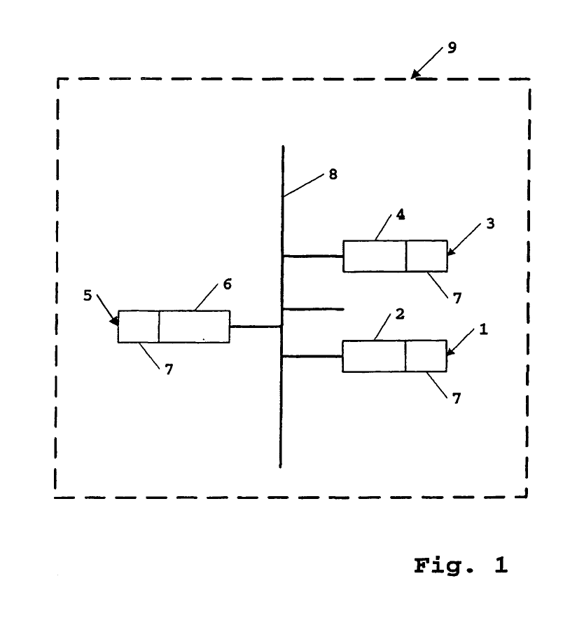

FIG. 1 shows an apparatus for carrying out the inventive method according to the invention. The components of a bus system in a vehicle 9 are connected to one another by means of a data bus 8, and preferably include controllers, sensors and actuators. The controllers 1, 3, 5 have appropriate software modules 2, 4, 6, 7 thereon.

The operating systems allow the controllers 1, 3, 5 (or their software modules 2, 4, 6, 7) to communicate with one another, using established standards in the field of software for vehicles. Examples of such standards are OSEK (open systems and their interfaces for electronics in motor vehicles), which has been adopted into ISO 15765-2 (http://www./osek-vdx.org), as a transport protocol between controllers, and the Keyword Protocol 2000, adopted into ISO 14230 (http://www.iso.org), for transmitting diagnostic data and providing diagnostic services.

The communication protocol available is the Keyword Protocol 2000 (KWP 2000), which is used in the vehicle industry as a communication protocol for diagnostic services and meets ISO 14230. Any other communication protocol may be used, however, provided that it performs the tasks below or meets ISO-14230.

Each of the controllers 1, 3, 5 has at least one microcontroller with a processor, memory and input/output unit for performing the controller function, a communication controller for implementing the communication protocol and a transmission/reception unit for connecting to the data bus 8. The data bus 8 is in the form of a CAN data bus with appropriate protocol functionality.

The software modules 2, 4, 6, 7 correspond to software-controlled applications that run on the respective controller 1, 3, 5, which are able to load a plurality of software modules.

The controllers 1; 3; 5 load the software modules 2; 4; 6 stored in the microcontroller's memory into their processor unit. These software modules 2; 4; 6 perform the primary tasks of the relevant controller 1; 3; 5. The software module 7 may also be loaded onto the controllers 1, 3, 5. The software module 7 corresponds to a secondary task of the controllers 1, 3, 5. The software module 7 is likewise stored in the memory of the microcontroller in the controllers 1, 3, 5.

By way of example, the controller 1 uses the software module 2 to perform engine control as its primary task, while the controller 3 uses the software module 4 for power train control as its primary task, and the controller 5 uses the software module 6 for controlling the braking system as its primary task.

As the secondary task, the software module 7 performs the calculation and creation of diagnostic data, for example, which are suitable for display in the vehicle and/or storage at a central location in the vehicle 9.

The software module 7 may be started in any controller 1, 3, 5, and, the controllers 1, 3, 5 support the input/output demands of the software module 7 for this purpose.

By way of example, operating data from sensors or actuators on the data bus 8 (such as oil temperature, servomotor position, etc.) are forwarded from the respective controller 1, 3, 5 as data to the software module 7.

The process time required by the software module 7 corresponds to the total time during which the software module 7 used a particular processor, from the time when it was started to the execution of its task. The processor time is particularly dependent on the clock frequency of the processor type used in the microcontroller of a controller 1, 3, 5.

The controllers 1, 3, 5 operate in process cycles. That is, after a particular time has elapsed, a process cycle needs to be terminated, and the data ascertained in the process output onto the data bus 8, after which the process cycle starts again. The process cycle for the controllers 1; 3; 5 is determined by the software modules 2; 4; 6 of the primary task and/or the operating system and/or the bus protocol. Accordingly, the processes which arise from the software modules 2, 4, 6 running on the processor of the respective microcontroller in the controller 1, 3, 5 are called primary processes.

When a process cycle or a process cycle time has elapsed, the controllers 1, 3, 5 send to the data bus 8 data which characterize their current processor utilization level, as well as the processor type used. From these data, the controllers 1, 3, 5 can ascertain the utilization level of the other controllers 1, 3, 5.

The utilization level of a processor attributed to performing the primary task of a controller 1, 3, 5 is not uniform, varies depending on the demand from the primary task. For example, the processor utilization level in the controller 5 as a result of the primary process is higher when braking than when not braking. Similarly, the processor utilization level of the controller 3 is higher when changing gear than when not changing gear.

The software module 7 can run on any of the various controllers 1, 3, 5. The decision regarding on which of the controllers 1, 3, 5 the software module 7 is started is dependent on the computation capacity; that is, the processor utilization level and the processor type, of the respective controller 1, 3, 5.

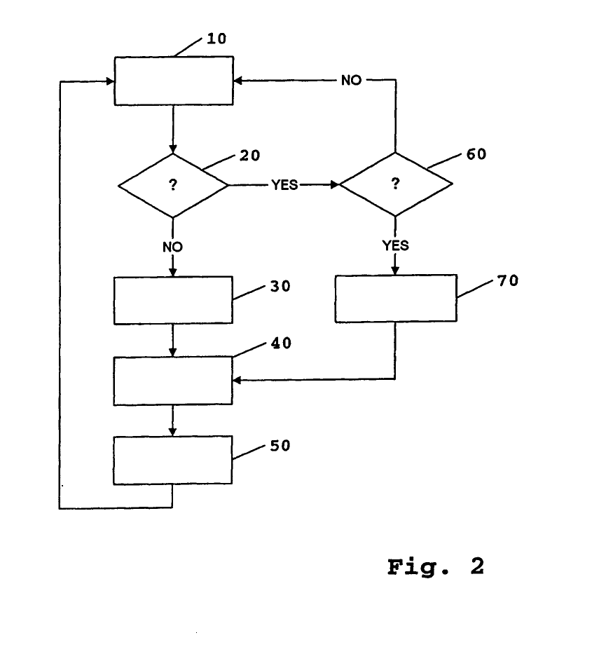

The method according to the invention will now be explained with reference to the flowchart shown in FIG. 2. It is assumed in this case that the processors in the controllers 1, 3, 5 are of identical type (that is, in particular, they have the same clock frequency), and are in ongoing operation:

A check is performed in step 10, to determine whether and on which controller 1, 3, 5 the software module 7 is running. (This check needs to be performed repeatedly, that is in particular time periods, since each of the controllers 1, 3, 5 is able to turn off the software module 7 when processor utilization level is high. As soon as has been turned off, the software module 7 needs to be started again.) The check to determine whether and on which controller 1, 3, 5 the software module 7 is running is performed by the software module 7 sending an appropriate identifier which contains these data to the data bus 8 in rotation or upon request.

In step 20, if an appropriate identifier, indicating operation of the software module 7 is not found on the data bus 8 in step 10, the process branches to step 30, in which it is established which of the controllers 1, 3, 5 connected to the data bus 8 has the maximum free computation capacity. (That is, which controller has the lowest processor utilization level in relation to the processor clock frequency.) This information can be obtained by the controllers 1, 3, 5 sending it in rotation or by means of a request. Assuming, for example, that in step 30 the controller 3 is determined currently to have the maximum free computation capacity. As a result, in step 40, software module 7 is started by the controller 3 determined in the previous step 30. The software module 7 then sends an identifier indicating its operation state (that is, that it is operating) and its operating controller (that is, the controller on which the software module 7 is running) to the data bus 8 in rotation or upon request and the process returns to step 10.

In step 10, it is determined once again whether and, if appropriate, which identifier for the software module 7 is present on the data bus. Because the software module 7 is running on controller 3, the process branches to step 60, in which controller 3 ascertains its own current processor utilization level within a process cycle, and compares it with the current computation capacity of the other controllers 1, 2 within a process cycle. To this end, it either requests the information regarding computation capacity (that is, processor utilization level and processor type) from the controllers 1, 2, or the controllers send this information to the data bus 8 in rotation.

If the utilization level of the processor in the controller 3 is lower than that of the processors in the other controllers 1, 2, no action occurs, and the software module 7 continues to run on the controller 3. The process returns to checking step 10 in rotation.

However, if it is found in step 60 that the utilization level of the processor in the controller 3 is higher than that of the processors in one of the other controllers 1, 2, in step 70, the software module 7 in the controller 3 is turned off. In addition, the controller 3 uses its data to ascertain the controller 1, 2 with the currently maximum free computation capacity. This might be the controller 1, for example, in which case the software module 7 is started by the controller 1, thus determined.

As soon as the software module 7 has been started correctly, in step 50 it sends to the data bus 8 (in rotation or upon request) an identifier indicating that it is running, as well as the controller on which it is running.

It is also possible for a plurality of different software modules to be distributed over the controllers 1, 3, 5 as secondary tasks. In addition, the controllers 1, 3, 5 may also perform a plurality of primary tasks.

The inventive method is preferably implemented at the operating system level of the controllers 1, 3, 5.

The data bus 8 may also be provided, for example, in the form of a FlexRay bus, an optical MOST or D2B bus, or an electrical LIN bus in a vehicle.

Advantageously, the inventive method may also be used in safety-related systems in vehicles. To increase failsafety, these systems are of redundant design, so that if a controller fails, for example, it is possible to change over to a controller of redundant design. Hence, systems of redundant design contain a plurality of controllers of the same type on which the same primary process runs, namely the redundant software application. The necessary similarity of the controllers implies that a software module which can be executed on one such controllers can also be executed on the associated other controllers, as well. This may be used for the application of the method according to this invention, by virtue of coordinate software applications that are also running on a controller in the redundant system.

In the method described above, the processor power of the controllers 1, 3, 5 is such that the software module 7 for the respective primary task of the controller 1, 3, 5 can always be connected in, without the primary process having to dispense with process time. The primary process therefore always receives priority over all other processes which are running on the processor. Should this not be the case, it is necessary to check in step 60 and in step 30 whether the free computation capacity available on the respective controller 1, 3, 5 is sufficient for handling the secondary task. If not, the software module 7 cannot be started in the relevant controller. For this calculation, the controllers 1, 3, 5 require advance knowledge of the process time for the software module 7 for a particular process type.

The method according to the invention may likewise be applied if the processor types in the controllers 1, 3, 5 are different. When the free computation capacity is determined, it is then necessary to take account not only of the processor utilization level but also of the processor type, that is to say particularly of the processor clock frequency.

The method can also be extended to controllers whose microcontrollers have a plurality of processors.

The method according to the invention may also be controlled by means of a central controller, which has the advantage that the central controller can distribute the appropriate software application to the controller in step 40 in addition to the decision and computation steps 20, 60, 30.

The foregoing disclosure has been set forth merely to illustrate the invention and is not intended to be limiting. Since modifications of the disclosed embodiments incorporating the spirit and substance of the invention may occur to persons skilled in the art, the invention should be construed to include everything within the scope of the appended claims and equivalents thereof.

1. A method for operating a software module on a processor unit in a controller networked via a data bus in a vehicle, wherein i) the software module is executable in a plurality of controllers which interchange data via the data bus, ii) selection of the controller on which the software module is operated is made based on the available computational capacity of the controllers which are currently in operation, and iii) each of the controllers can turn off the software module when a utilization level of its processor is high, and as soon as the software module has been turned off, the software module is to be started again on another controller: said method comprising:
a software module in a controller on which said software module is running sending to the data bus, either cyclically or upon request, an appropriate identifier containing information indicating its operating status and the identity of the controller on which it is running;
checking cyclically to determine whether and on which controller the software module is running, based on said identifier; and
determining which of the controllers has the greatest free computation capacity, taking into account its processor clock frequency;
wherein said determining step is made by virtue of the controllers involved sending in rotation or by means of a request, information that is indicative of their available computational capacity.

2. The method as claimed in claim 1, wherein before the software module is executed it is ascertained which of the controllers provides the maximum free computation capacity and the software module is started on the determined controller.

3. The method as claimed in claim 1, wherein the controller on which the software module is running compares its computation capacity with the computation capacity of the other controllers and either continues to operate or terminates operation of the software module based on the comparison.

4. The method as claimed in claim 1, wherein the computation capacity of a controller is ascertained from the processor utilization level and processor type.

5. The method as claimed in claim 1, wherein the software module is started on a controller having the maximum free computation capacity.

6. The method as claimed in claim 1, wherein the software module is stored in a memory in the controllers .

7. The method as claimed in claim 1, wherein:
an identifier for the software module is sent to the data bus cyclically or upon request; and
the identifier contains information about an operating state and the operating controller of the software module.

8. A networked controller having software modules stored in a controller's memory wherein:
a software modules perform primary control tasks;
a software module with a subsidiary task can be additionally stored in a microcontroller's memory by the controllers;
the controllers have process cycles;
a process cycle is terminated after a particular time has elapsed, the data ascertained in the process are output onto the data bus, and the process cycle is started again;
the process cycle for the controllers is determined by the software modules for one of the primary task, the operating system and a bus protocol; and
when a process cycle or a process cycle time has elapsed, data are sent to the data bus which characterize their current processor utilization level and processor type used, with the controllers using these data to ascertain the utilization level of the other controllers.

9. A method of operating a network of controllers which are coupled via a data bus, each of which controllers has at least one processor, and has installed thereon the same software module which can be executed by the processor contained in any one of the controllers, each of said controllers being configured such that it can turn off the software module when a utilization of its processor is high, said method comprising:
each controller sending via the data bus, information regarding a current utilization level of its at least one processor;
whenever said software module is running in a particular one of said controllers, said software module in said particular controller sending via the data bus, an identifier indicating its operating state and identifying the particular controller;
checking said data bus to determine whether an identifier is present;
if no identifier is found in said checking step, determining which of the controllers has the greatest available computation capacity, based on its current utilization level as sent via the data bus;
said controller with said greatest available utilization level starting operation of said software module, and said software module sending to said data bus, an identifier indicating its operating status and the identity of the controller in which it is running;
if an identifier is present on the data bus in said checking step, the controller on which said software module is running ascertaining its own processor utilization level and comparing its computation capacity with the available computational capacity of other controllers coupled via the data bus;
if the utilization level of the controller on which the software module is greater than that of one of said other controllers, said controller on which said software module is running ceasing operation of said software module; and
said one of said other controllers starting operation of said software module, and said software module sending to said data bus an identifier indicating that it is running and identifying said one controller.
